(19) United States
(12) Patent Application Publication
(10) Pub. No.: US 2025/0138383 A1
(43) Pub. Date: May 1, 2025

(54) Device for Controlling Thermal Properties of Windows

(71) Applicant: UNIVERSITY COLLEGE DUBLIN, NATIONAL UNIVERSITY OF IRELAND, 4 Dublin (IE)

(72) Inventor: Dominic Zerulla, Dormagen (DE)

(21) Appl. No.: 18/837,136

(22) PCT Filed: Feb. 8, 2023
(86) PCT No.: PCT/EP2023/053132

§ 371 Date: Aug. 8, 2024

(30) Foreign Application Priority Data
Feb. 8, 2022 (GB) 2201594.5

(51) Int. Cl. G02F 1/169; E06B 9/24

(52) U.S. Cl. CPC G02F 1/169; E06B 9/24; E06B 2009/2464; G02F 2201/083; G02F 2202/36

(57) ABSTRACT

A device (1) is provided for controlling transmission of electromagnetic radiation through a transparent substrate. The device comprises a first plurality of electrodes (5a, 5b) arranged as a first layer (2) and a second plurality of electrodes (8a, 8b) arranged as a second layer (4) spaced apart from the first layer. A carrier material (6) is located between the first plurality of electrodes and the second plurality of electrodes comprising a plurality of molecules (10) configured to change their orientation in the presence of an electric field thereby to alter the transmission of electromagnetic radiation through the device. The first plurality of electrodes and the second plurality of electrodes are configured to generate an electric field in the carrier material upon application of a potential difference between the first and second plurality of electrodes, to alter the transmission of electromagnetic radiation through the device.

### FIELD

The present invention is directed to solutions for improving the thermal properties of transparent substrates, such as windows. In particular, the present invention relates to a device that can vary the transmission of radiation through a windowpane.

### BACKGROUND

Climate change and carbon emissions are pressing issues now and will continue to be so for the foreseeable future. At present over 40% of global carbon emissions are from buildings, such as our homes and workplaces, with the big driver being the difficulty to regulate the temperature due to unwanted heat gain and unwanted heat loss depending on the time of the year. For instance, it is estimated that 40% of a typical buildings cooling costs may be due to solar heat gain through windows. There is a clear need for innovation and disruption in the glazing industry if our current buildings are to meet zero-net-carbon standards.

The most dominant technology on the market aimed at reducing solar heat gain and loss through windows is passive low E-Glass. At its most simple this involves placing a thin transparent film on a pane of glass to block the transfer of heat in or out of the building. The critical element of this technology is that it is passive and cannot be altered as weather conditions/temperatures change.

There is the need for improved glazing solutions for aiding in improving their thermal properties to maintain our buildings internal temperatures reducing unwanted heat transfer through windows.

### SUMMARY OF INVENTION

According to a first aspect there is provided a device for controlling transmission of electromagnetic radiation through a transparent substrate the device comprising: a first plurality of electrodes arranged as a first layer, the first layer defined by a first axis and a second axis, where the second axis is orthogonal to the first axis, the first plurality of electrodes spaced apart from each other along the first axis, at least some of the first plurality of electrodes configured to be independently controllable to each other; a second plurality of electrodes arranged as a second layer, the second layer defined by the first axis and the second axis, the second plurality of electrodes spaced apart from each other along the first axis, and the second layer spaced apart from the first layer along an axis perpendicular to the first and second axis, at least some of the second plurality of electrodes configured to be independently controllable to each other; a carrier material located between the first plurality of electrodes and the second plurality of electrodes, the carrier material comprising: a plurality of molecules configured to change their orientation in the presence of an electric field thereby to alter the transmission of electromagnetic radiation through the device; wherein the first plurality of electrodes and the second plurality of electrodes are configured to generate an electric field in the carrier material upon application of a potential difference between the first and second plurality of electrodes, such that the plurality of molecules orientate along a direction in the presence of the electric field thereby to alter the transmission of electromagnetic radiation through the device.

Advantageously, by having a first plurality of electrodes, each of which are arranged along the first axis (i.e., spaced apart from each other), and a second plurality of electrodes, each of which are arranged along the first axis (i.e., spaced apart from each other), the orientation of the molecules in the carrier material can be controlled. This is enabled by each of the first and second plurality of electrodes being independently controllable such that different voltages can be applied to electrodes of the first plurality of electrodes and second plurality of electrodes to tailor the direction in which the electric field experienced by the molecules is generated. This enables control of the molecule's orientation and thus control of the properties of transmission of radiation (and therefore heat) through the device. Thus, the device may permit different rates of transmission of electromagnetic radiation through the device at different regions, depending on the local orientation of the molecules. For instance, when applied to a transparent substrate, such as a window, different regions of the substrate may allow varying transmission of radiation to each other depending on the local orientation of molecules in each region. When the molecules are in one orientation transmission of radiation through the device may be reduced compared to when the molecules are in a different orientation.

Further advantageously, the device may allow selective passage of radiation through the device depending on the direction that the radiation is incident on the device as the orientation of the molecules may influence the transmission of radiation through the device. For instance, when the molecules have certain orientations with respect to incoming radiation the molecules may prevent, or reduce, the transmission of radiation due to the direction that the molecules are orientated. Likewise, when the molecules have certain orientations with respect to incoming radiation the molecules may allow, the transmission of radiation due to the direction that the molecules are orientated. This means that light incident from different directions may be affected differently. Thus, it may be used to prevent the passage of light through the device from one direction (such as the direction that the sun's light is directly incident on the device) than in other directions. This can act as stopping the radiation directly from the sun from passing through the device, but allowing radiation (e.g., light) to pass through from other directions (i.e. not directly from the sun). This can aid in the thermal properties when the device is applied to a substrate (such as a windowpane) whilst still allowing the passage of background light thus keeping a high transparency for the window. To an observer on the opposite side of the window system to the external source of radiation this may have the appearance of a dark area over their view of the external source of radiation, whilst the remaining view through the windowpane being unobstructed.

The electrodes are independently controllable in that a voltage applied to one electrode of the first plurality of electrodes need not necessarily be applied to the other electrodes of the first plurality of electrodes. Likewise, a voltage applied to one electrode of the second plurality of electrodes need not necessarily be applied to the other electrodes of the second plurality of electrodes. The electrodes of the first plurality of electrodes may also be independently controllable to the electrodes of the second plurality of electrodes. As such, an electric potential can be applied to each of the electrodes independently of each other.

The electric field generated by the first plurality of electrodes and the second plurality of electrodes may be such that the plurality of molecules may orientate along a direction in the presence of the electric field between the first axis and the axis perpendicular to the first and second axis.

Altering the transmission of electromagnetic radiation may include reducing the transmission. Altering/reducing may include altering/reducing the absorption and/or reflection of electromagnetic radiation through the device. Transmission of electromagnetic radiation may be transmission of visible, UV, IR, and/or other types of radiation. Each of these processes may be responsible for the transfer of heat through the window.

Preferably, the first plurality of electrodes and the second plurality of electrodes may be configured such that when a potential difference is applied between a first electrode of the first plurality of electrodes, positioned at a first position along the first axis, and a first electrode of the second plurality of electrodes, positioned at a second position along the first axis, the molecules are configured to orientate along a direction defined between the first position and the second position.

Along a direction may be in the direction of the generated electric field. For instance, the molecules may orientate along the electric field lines caused by the potential difference between the electrodes. In other arrangements the molecules may orientate in a direction that is perpendicular to the direction of the electric field, for instance perpendicular to the electric field lines. The orientation of the molecules may in some instances not change in response to application of a particular electric field if the molecules are already orientated with respect to the electric field. Subsequently applying an electric field in a different direction may cause a further re-orientation of the molecules.

In some arrangements, only the molecules located (in a region) between the first electrode of the first plurality of electrodes, and the first electrode of the second plurality of electrodes, between which the potential difference is applied, may be orientated by the potential difference. Molecules located at other regions along the first axis may not be orientated by the electric field as the magnitude of the electric field generated by the potential difference in these regions may be too small to have an effect. In some arrangements, the device may be controlled such that potential difference is applied to different electrodes of the first plurality of electrodes and second plurality of electrodes at different times to affect the orientation of molecules adjacent each of the different electrodes. For instance, a voltage may be applied to certain electrodes at different times to others. This enables control of the molecules in the local area adjacent the electrodes that a voltage has been applied to, and this permits selective control of the orientation of the molecules.

Preferably, the first position may be at a different position along the first axis to the second position. In this way, the transmission of radiation through the device can be varied by selecting an appropriate difference in position between the first electrode of the first plurality of electrodes and the first electrode of the second plurality of electrodes. For instance, by selecting electrodes that have a larger difference in position the molecule orientation will differ to selecting electrodes that have a smaller difference in position. In other arrangements, the first position may be the same as the second position. In such an arrangement the molecules may be orientated perpendicular to the first direction (i.e. perpendicular to the plane defined by the first layer).

Each electrode of the first plurality of electrodes may have a position along the first axis and each electrode of the second plurality of electrodes may have a position along the first axis. The orientation of the molecules can be controlled by applying a voltage to an electrode in the first plurality of electrodes at a different position along the first axis to the electrode in the second plurality of electrodes to which a voltage is applied. Thus, the direction of the generated electric field can be controlled through controlling the potential difference between the electrodes in the first and second plurality of electrodes. For instance, voltage may be applied to an electrode of the first plurality of electrodes at a first position along the first axis and a voltage may be applied to an electrode of the second plurality of electrodes at a second position along the first axis, where the first and second position are different positions along the first axis, with neighbouring electrodes at positions next to the first and second position to those that the voltage is applied may be configured to have no voltage applied to them (or a reduced voltage compared to the electrodes at the first and second position). This may cause an electric field to be set up between the first and second positions thereby causing the molecules within the carrier material of this field to be orientated in a direction between the first and second positions i.e., along the field lines.

A further use of this is that different regions of the device can allow different transmission to other regions of the device. For instance, the orientation of molecules in certain regions of the device may be orientated in a certain direction (through applying potential difference to electrodes only in these regions) whereas molecules in other regions may be orientated differently and no potential difference applied to electrodes in these regions. This can enable the device to tailor its thermal properties in different regions of the device.

The device may further comprise a third plurality of electrodes spaced apart from each other substantially along the second axis, the third plurality of electrodes configured to be independently controllable to each other; and a fourth plurality of electrodes spaced apart from each other substantially along the second axis, the fourth plurality of electrodes configured to be independently controllable to each other.

In this way, the third and fourth plurality of electrodes can act to control the orientation of the molecules in a further dimension providing a further degree of control. This can aid in making the device have an enhanced control of transmission of electromagnetic radiation. For instance, the first and second plurality of electrodes may control the orientation of the molecules over elevation angles, and the third and fourth plurality of electrodes may control the orientation of the molecules over azimuth angles. Radiation from an external source may have polarisation in a number of different axes. For instance, polarisation of transverse electro-magnetic radiation (e.g. light) is always perpendicular to its propagation direction i.e. the plane of polarisation of the incoming light will be perpendicular to the direction of incidence of the light. The first and second plurality of electrodes may act to prevent light that is polarised in an axis and the third and fourth plurality of electrodes may act to prevent light that is polarised in a perpendicular axis. This enables light having any polarisation to be blocked as minimum level of transmission can be reached when all polarisations within the plane can be rejected (through absorption and/or reflection). The first and second plurality of electrodes operate together in the same way as the third and fourth plurality of electrodes, albeit by controlling the orientation in an orthogonal direction.

Preferably, the third plurality of electrodes may be positioned between the first plurality of electrodes and the carrier material, and/or the fourth plurality of electrodes positioned between the second plurality of electrodes and the carrier material.

Preferably, the third plurality of electrodes and the fourth plurality of electrodes may be configured to generate an electric field in the carrier material upon application of a potential difference between the third and fourth plurality of electrodes, such that the plurality of molecules orientate along a direction in the presence of the electric field between the second axis and the axis perpendicular to the first and second axis thereby to alter the transmission of electromagnetic radiation through the device.

The electric field generated, and the resulting orientation of the molecules, may be influenced by a combination of the electric field generated by both the first and second and third and fourth plurality of electrodes. In other arrangements, voltage may be applied to the first and second plurality of electrodes, and at a subsequent point in time voltage may be applied to the third and fourth plurality of electrodes.

The third and fourth plurality of electrodes may each be formed as a respective layer that are defined by the first and second axis.

In some arrangements, the carrier material is a first layer of carrier material, and the device further comprises: a second layer of carrier material comprising a plurality of molecules, the second layer of carrier material arranged between the third plurality of electrodes and the fourth plurality of electrodes, wherein the third plurality of electrodes and the fourth plurality of electrodes are configured to generate an electric field in the second layer of carrier material upon application of a potential difference between the third and fourth plurality of electrodes, such that the plurality of molecules in the second layer of carrier material orientate along a direction in the presence of the electric field thereby to alter the transmission of electromagnetic radiation through the device. Thus, the first layer of carrier material may be affected by only the electric field produced by the first and second plurality of electrodes, and the second layer of carrier may be affected by only the electric field produced by the third and fourth plurality of electrodes. In this way, each layer of carrier material may be configured to attenuate a different polarisation direction of the incoming radiation to each other through the controlling of the molecule orientation (i.e. perpendicular polarisation directions to each other). The electric field generated by the third plurality of electrodes and the fourth plurality of electrodes may be such that the plurality of molecules may orientate along a direction in the presence of the electric field between the second axis and the axis perpendicular to the first and second axis.

Although the third and fourth plurality of electrodes may be spaced apart along substantially the second axis (and each electrode elongate along the first axis) and the first and second plurality of electrodes may be spaced apart along substantially the first axis (and each electrode elongate along the second axis) the difference in orientation between the electrodes need not necessarily be 90°, so long as there is a large angular difference between their arrangements.

Preferably, each of the first plurality of electrodes, and/or second plurality of electrodes may be elongate such that they extend substantially along the second axis.

For instance, each of the first plurality of electrodes may extend perpendicular to the first axis, and each of the second plurality of electrodes may extend perpendicular to the first axis. The third plurality of electrodes may extend parallel to the first axis, and each of the fourth plurality of electrodes may extend parallel to the first axis. Each of the first plurality of electrodes may be spaced apart from each other by a gap between adjacent electrodes. This enables each of the first plurality of electrodes to be electrically insulated from each other. Likewise, each of the second, third, and fourth plurality of electrodes may be respectively spaced apart from each other by a gap between adjacent electrodes.

In other arrangements the electrodes may have a different shape to elongate. For instance, they may have a square shape. In this way further control of the electric field can be generated as a larger number of electrodes can be accommodated in the same shape enabling different electrodes along the second axis can be switched on or off as required. In other arrangements, the electrodes may be curved, rather than straight.

The electrodes are preferably comprised of electrically conductive material. In the arrangements showed here the electrodes are formed of Indium Tin Oxide (ITO). However, the electrodes may be made of any thin metal films, and/or transparent conductive oxides, or conductive polymers. For instance, the electrodes may alternatively be made of Fluorinated Tin Oxide (FTO).

As the first plurality of electrodes are arranged as a first layer each of the first plurality of electrodes are preferably arranged at the same position to each other along the axis perpendicular to the first and second axis. Likewise, as the second plurality of electrodes are arranged as a second layer each of the second plurality of electrodes are preferably arranged at the same position to each other along the axis perpendicular to the first and second axis. As the first layer and the second layer are different, the position along the axis perpendicular to the first and second axis of the first plurality of electrodes is preferably different to the position along the axis perpendicular to the first and second axis of the second plurality of electrodes. Each of the first layer and second layer (and third and fourth layer) define a plane in the first and second axis.

However, in some arrangements it would be understood that the first layer may have a depth in the axis perpendicular to the first and second axis such that each of the first plurality of electrodes need not be at the same position in the axis perpendicular to the first and second axis. Likewise, it would be understood that the second layer may have a depth in the axis perpendicular to the first and second axis such that each of the second plurality of electrodes need not be at the same position in the axis perpendicular to the first and second axis. In these arrangements, this depth of each layer would be smaller (i.e., insignificant) compared to the distance (i.e., difference in position) between the first and second layers (along the axis perpendicular to the first and second axis). The above is also applicable to the third and fourth layers of electrodes.

The molecules are preferably anisotropic molecules. In other words, the molecules are non-spherical and have two axes that are different to each other. For instance, the molecules can be approximated as having a simplified shape having a long axis that is much shorter than their short axis. For instance, they may be rod-shaped. In this way, the molecules have properties that depend on the orientation of the molecule. For instance, along one axis the molecules may permit the passage of radiation, but along a different axis they may not allow the passage of radiation. The molecules may be carbon nanotubes. In other arrangements they may be any type of molecules which are sufficiently absorptive/reflective with respect to the wavelengths of the incoming electromagnetic radiation and which can be oriented in an external electric (or even magnetic) field can be used. For instance, this may include long chain organic molecules which exhibit an approximately rod-like outer shape or a shape deviating from a sphere. These can be polarised by an external field and would align the field lines with their long main axis. Their optical properties could be tailored by introducing aromatic antenna complexes into their chains in a similar way to molecules used for organic (Dye-sensitized) solar cells.

Preferably, the carrier material may be a gel. The carrier material may be located between the first plurality of electrodes and the second plurality of electrodes i.e., along a direction perpendicular to the first and second axis. The carrier material may act to contain the molecules such that the molecules are held in position, i.e., to contain the molecules in a region within the device. However, the containment provided by the carrier material can be overcome in the presence of the electric field to allow re-orientation of the molecules as described above.

In some arrangements the gel may be hydrogels (especially gelatine). However, any other gel compositions will work such as Organogels, Xerogels, nanocomposite gels. Gels may be defined as a substantially dilute cross-linked system, which exhibits no flow when in the steady-state, although the liquid phase may still diffuse through this system. A gel may be defined phenomenologically as a soft, solid or solid-like material consisting of two or more components, one of which is a liquid, present in substantial quantity. An important property of the gel is its viscosity (and the fact that it needs to be sufficiently transparent with respect to the thickness of the layer used). It needs to be sufficiently viscous to hold the “optically active” molecules in place, without hindering their motion within the electric field.

Preferably, the transparent substrate may be for use in a window. The transparent substrate may have major surfaces which forms a plane that extends along the first and second axis. In other words, the device may be configured to be arranged on or adjacent to the major surfaces.

Preferably, the molecules may be configured to maintain their orientation once the potential difference has been removed. In this way, the voltage applied to each of the electrodes may be pulsed. Upon application of a pulse of voltage the potential difference between the electrodes may cause the orientation of the molecules to change (if the electric field is in a direction to cause the change) and after the pulse the orientation of the molecules may remain in the orientation until a further pulse of voltage is applied. Advantageously, this enables the molecules to have a memory in that they do not require a continuous voltage supply to maintain a particular orientation. This keeps the amount of energy consumed by the device to a minimum by only applying voltage when a change is required. The voltage may be typically, in the range of 1V to 4V (as in hydrogels it is desired to stay below the point of electrolysis), but higher or lower voltages might work for different gel/active molecule combinations. In other arrangements the molecules may be configured such that a continuous voltage is required to maintain their orientation. The voltage applied may be AC or DC. For instance, transient square wave pulses of voltage may be used.

According to a further aspect there is provided a window comprising: the device of the above aspect; and a windowpane comprised of transparent substrate. Application of the device of the above aspect in a window can enable the transmission of electromagnetic radiation through the window to be controlled.

The window may comprise a first windowpane and a second windowpane positioned apart from each other along the axis perpendicular to the first and second axis, wherein the device is in a region defined between the first and second windowpanes, such that the first plurality of electrodes are adjacent to the first windowpane and the second plurality of electrodes are adjacent to the second windowpane.

In this way, the device may be contained between the two windowpanes. For instance, in a double-glazing system the device may be located between the inner and outer windowpanes. The first plurality of electrodes may be nearest the first windowpane and the second plurality of electrodes may be nearest the second windowpane. For instance, the first plurality of electrodes may be attached to the first windowpane and the second plurality of electrodes may be attached to the second windowpane.

The window may comprise a first windowpane and a second windowpane positioned apart from each other along the direction perpendicular to the first and second axis, wherein the first windowpane is located between the first plurality of electrodes and the third plurality of electrodes, and the second windowpane is located between the second plurality of electrodes and the fourth plurality of electrodes.

In this way, the windowpanes act as an insulating layer between the electrodes. Specifically, the first windowpane acts as electrical insulation between the first plurality of electrodes and the third plurality of electrodes, and the second windowpane acts as electrical insulation between the second plurality of electrodes and the fourth plurality of electrodes. This enables the electrodes to be independently charged and does not require the use of additional insulator material between the electrodes.

In other arrangements, the device may be contained between the two windowpanes with the third plurality of electrodes located between the first windowpane and the first plurality of electrodes, and the fourth plurality of electrodes located between the second windowpane and the second plurality of electrodes. Likewise, the first plurality of electrodes located between the first windowpane and the third plurality of electrodes, and the second plurality of electrodes located between the second windowpane and the fourth plurality of electrodes. In other arrangements, the device may be located on one side of a windowpane such that all electrodes are on one side of the windowpane.

In other arrangements, there may be two layers of carrier material. In this arrangement the first plurality of electrodes may be located adjacent the first window pane and the fourth layer of electrodes may be located adjacent the second windowpane. In this arrangement the first and second plurality of electrodes may be located either side of a first layer of carrier material, and the third and fourth plurality of electrodes may be located either side of a second layer of carrier material.

The windowpane may have a first major surface and a second major surface, the first and second major surfaces defined by the first and second axes. The first and second major surfaces each define a plane formed from the first and second axes. The first axis may be the y-axis, and the second axis may be the x-axis. In this notation then the axis perpendicular to the first and second axis may be the z-axis.

Preferably, the transparent substrate is glass. In other arrangements, the transparent substrate may be a plastic material, such as Perspex™.

According to a further aspect there is provided a method of controlling transmission of electromagnetic radiation through a transparent substrate the method comprising: arranging a first plurality of electrodes as a first layer, the first layer defined by a first axis and a second axis, where the second axis is orthogonal to the first axis, the first plurality of electrodes spaced apart from each other along the first axis, at least some of the first plurality of electrodes configured to be independently controllable to each other; arranging a second plurality of electrodes as a second layer, the second layer defined by the first axis and the second axis, the second plurality of electrodes spaced apart from each other along the first axis, and the second layer spaced apart from the first layer along an axis perpendicular to the first and second axis, at least some of the second plurality of electrodes configured to be independently controllable to each other; arranging a carrier material located between the first plurality of electrodes and the second plurality of electrodes, the carrier material comprising: a plurality of molecules configured to change their orientation in the presence of an electric field thereby to alter the transmission of electromagnetic radiation through the device; wherein the first plurality of electrodes and the second plurality of electrodes are configured to generate an electric field in the carrier material upon application of a potential difference between the first and second plurality of electrodes, such that the plurality of molecules orientate along a direction in the presence of the electric field thereby to alter the transmission of electromagnetic radiation through the device.

Preferably, the electric field generated by the first plurality of electrodes and the second plurality of electrodes may be configured such that the plurality of molecules orientate along a direction in the presence of the electric field between the first axis and the axis perpendicular to the first and second axis.

Preferably, the method may further comprise applying a potential difference between a first electrode of the first plurality of electrodes, positioned at a first position along the first axis, and a first electrode of the second plurality of electrodes, positioned at a second position along the first axis, such that the molecules located in a region defined between the first electrode of the first plurality of electrodes and the first electrode of the second plurality of electrodes orientate along a direction defined between the first position and the second position.

Preferably, the method may further comprise: switching off the potential difference between the first electrode of the first plurality of electrodes, positioned at the first position along the first axis, and the first electrode of the second plurality of electrodes, positioned at the second position along the first axis; and subsequently to the step of switching off: applying a potential difference between a second electrode of the first plurality of electrodes, positioned at a third position along the first axis, and a second electrode of the second plurality of electrodes, positioned at a fourth position along the first axis, such that the molecules, located in a region defined between the second electrode of the first plurality of electrodes and the second electrode of the second plurality of electrodes, orientate along a direction defined between the third position and the fourth position; wherein the first position is different to the third position, and the second position is different to the fourth position.

In this way, by sequentially switching the electrodes on and off (i.e., applying voltage to the electrode and then stopping application of the voltage) the molecules can be orientated in a specific orientation. For instance, by switching the first electrodes on the molecules positioned between the first electrodes will be caused to orientate such that they align along the field lines formed between the first electrodes. Once the potential difference to the first electrodes is switched off the molecules will preferably maintain their orientation. By then switching on the second electrodes, the same effect will be achieved for the molecules positioned between the second electrodes. Preferably, the difference in position between the first and second position will be the same as the difference in position between the third and fourth positions. Thus, the orientation of the molecules between the first electrodes (i.e., of the first and second plurality of electrodes) will be the same as the orientation of the molecules between the second electrodes (i.e., of the first and second plurality of electrodes). By sequentially applying a potential difference between different electrodes at different positions the molecules along the length of the device can be orientated in the same orientation. This also allows the possibility of different regions of the device to orientate molecules in different orientations to each other by varying the positional difference between the electrodes (of the first plurality of electrodes and second plurality of electrodes) when switched on.

The method may further comprise, arranging a third plurality of electrodes spaced apart from each other substantially along the second axis, the third plurality of electrodes configured to be independently controllable to each other; and
arranging a fourth plurality of electrodes spaced apart from each other substantially along the second axis, the fourth plurality of electrodes configured to be independently controllable to each other;
   wherein the third plurality of electrodes and the fourth plurality of electrodes are configured to generate an electric field in the carrier material upon application of a potential difference between the third and fourth plurality of electrodes, such that the plurality of molecules orientate along a direction in the presence of the electric field thereby to alter the transmission of electromagnetic radiation through the device, or wherein the carrier material is a first layer of carrier material, and the device further comprises: a second layer of carrier material comprising a plurality of molecules, the second layer of carrier material arranged between the third plurality of electrodes and the fourth plurality of electrodes, and wherein the third plurality of electrodes and the fourth plurality of electrodes are configured to generate an electric field in the second layer of carrier material upon application of a potential difference between the third and fourth plurality of electrodes, such that the plurality of molecules in the second layer of carrier material orientate along a direction in the presence of the electric field thereby to alter the transmission of electromagnetic radiation through the device.

Preferably, the electric field generated by the third plurality of electrodes and the fourth plurality of electrodes is configured such that the plurality of molecules orientate along a direction in the presence of the electric field between the second axis and the axis perpendicular to the first and second axis.

Preferably, the method may further comprise:
applying a potential difference between a first electrode of the third plurality of electrodes, positioned at a first position along the second axis, and a first electrode of the fourth plurality of electrodes, positioned at a second position along the second axis, such that the molecules located in a region defined between the first electrode of the third plurality of electrodes and the first electrode of the fourth plurality of electrodes orientate along a direction defined between the first position (the first position along the second axis) and the second position (the second position along the second axis).

Preferably, the method may further comprise:
switching off the potential difference between the first electrode of the third plurality of electrodes, positioned at the first position along the second axis, and the first electrode of the fourth plurality of electrodes, positioned at the second position along the second axis; and
subsequently to the step of switching off:
   applying a potential difference between a second electrode of the third plurality of electrodes, positioned at a third position along the second axis, and a second electrode of the fourth plurality of electrodes, positioned at a fourth position along the second axis, such that the molecules, located in a region defined between the second electrode of the third plurality of electrodes and the second electrode of the fourth plurality of electrodes, orientate along a direction defined between the third position and the fourth position (the first and second position along the second axis); wherein the first position along the second axis is different to the third position along the second axis, and the second position along the second axis is different to the fourth position along the second axis.

Switching off may involve switching off so that no voltage is applied, or it may involve reducing the voltage applied.

### DESCRIPTION OF DRAWINGS

FIG. 1 is a perspective exploded view of a window comprising a mechanism for controlling the transmission of electromagnetic radiation through the window according to an aspect of the invention.

FIG. 2 is a perspective view of the window comprising a mechanism for controlling the transmission of electromagnetic radiation through the window of FIG. 1;

FIG. 3 is a side on cross sectional view of the window comprising a mechanism for controlling the transmission of electromagnetic radiation through the window of FIG. 1;

FIG. 4 is a side on cross sectional view of a portion of the window comprising a mechanism for controlling the transmission of electromagnetic radiation through the window of FIG. 1 showing details of the electrodes and molecules between the electrodes;

FIGS. 5A to 5C show a series of side on cross sectional views of a portion of the window comprising a mechanism for controlling the transmission of electromagnetic radiation through the window of FIG. 1 showing how controlling orientation of the molecules can be achieved through selectively applying voltage to different electrodes;

FIG. 6 shows a series of side on cross sectional views of the window comprising a mechanism for controlling the transmission of electromagnetic radiation through the window of FIG. 1 showing how controlling orientation of the molecules can be achieved through selectively applying voltage to different electrodes;

FIG. 7 shows a further series of side on cross sectional views of the window comprising a mechanism for controlling the transmission of electromagnetic radiation through the window of FIG. 1 showing how controlling orientation of the molecules can be achieved through selectively applying voltage to different electrodes;

FIG. 8 is a perspective exploded view of a window comprising a mechanism for controlling the transmission of electromagnetic radiation through the window according to a further aspect of the invention;

FIG. 9 is a perspective view of the window comprising a mechanism for controlling the transmission of electromagnetic radiation through the window of FIG. 8;

FIG. 10 is a side on cross sectional view of the window comprising a mechanism for controlling the transmission of electromagnetic radiation through the window of FIG. 8;

FIG. 11 is a front view of layers that make up a portion of the mechanism of FIG. 8;

FIG. 12 is a side on cross sectional view of a window comprising a mechanism for controlling the transmission of electromagnetic radiation through the window according to a further aspect of the invention;

FIG. 13 shows a coordinate-axis system demonstrating the angles over which the molecules can be orientated of the device in FIGS. 7 to 12; and

FIG. 14 shows is a perspective exploded view of a window comprising a mechanism for controlling the transmission of electromagnetic radiation through the window according to a further aspect of the invention.

### DETAILED DESCRIPTION

The present invention is directed to a device (otherwise referred to as mechanism) used within a window to control the transmission of electromagnetic radiation through the window. One advantage of the device is its ability to control transmission of electromagnetic radiation through the window differently throughout different regions of the window. A further feature is the ability to adjust, i.e., reduce or increase, the transmission of electromagnetic radiation through the window in real time. This can enable the window to respond to outside (and inside) temperatures aiding in thermal regulation of the building in which it is used as transfer of heat through the window can be controlled.

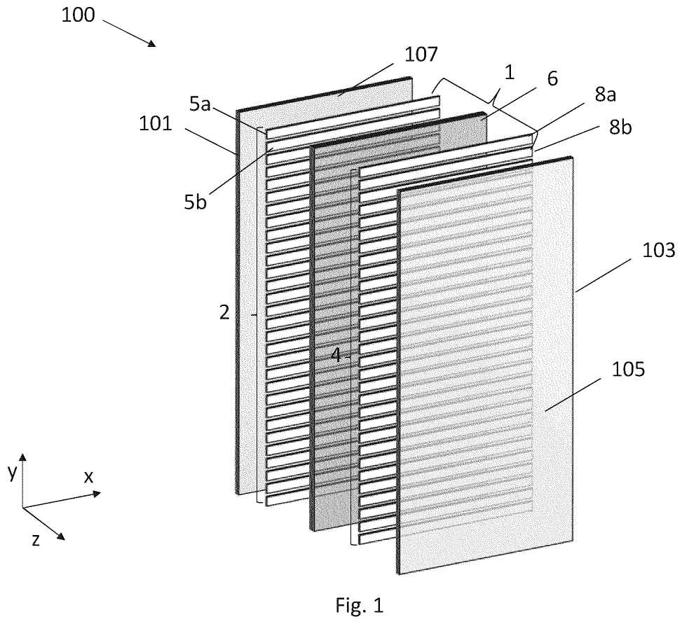

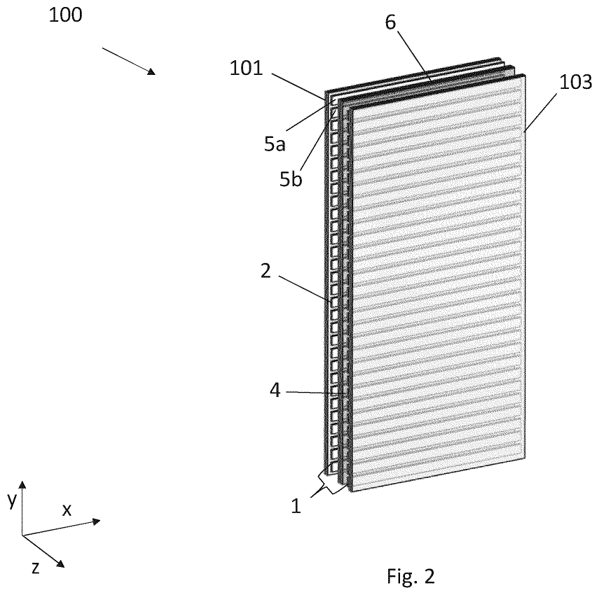

FIG. 1 is a perspective exploded view of a window 100 comprising a mechanism 1 for controlling the transmission of electromagnetic radiation through the window according to an aspect of the invention. FIG. 2 is a perspective view of the window 100, comprising a mechanism 1 for controlling the transmission of electromagnetic radiation through the window of FIG. 1.

As can be seen the window 100 comprises two glass panes 101 and 103. The mechanism 1 is located between the glass panes 101 and 103 such that the glass panes 101 and 103 sandwich mechanism 1. The mechanism 1 consists of a series of layers. A layer of electrodes 2 are located adjacent the glass pane 101, and a layer of electrodes 4 are located adjacent the glass pane 103. A gel layer 6 is located between the layer of electrodes 2 and layer of electrodes 4.

The layer of electrodes 2 contains a plurality of electrodes (such as 5a 5b) arranged within the layer. Likewise, the layer of electrodes 4 contains a plurality of electrodes (such as 8a 8b) arranged within the layer. Each of the electrodes of the layer 2 and layer 4 have an elongate shape that extends along an axis, i.e., the x-axis as shown in FIGS. 1 and 2. Each of the plurality of electrodes of the layer 2 are spaced apart from each other along the y-axis by an insulating gap, and each of the plurality of electrodes of the layer 4 are spaced apart from each other along the y-axis by an insulating gap. The layer of electrodes 2 is spaced apart from the layer of electrodes 4 along the z-axis (as shown in FIGS. 1 and 2).

Each windowpane 101 103 have two opposing major surfaces extending in the x-y plane. Only one major surface can be seen in FIG. 1 for each windowpane, with major surface 105 visible for windowpane 103, and major surface 107 visible for windowpane 101.

The gel layer 6 includes a viscous gel matrix having anisotropic molecules located within. In the examples shown the anisotropic molecules are single walled carbon nanotubes.

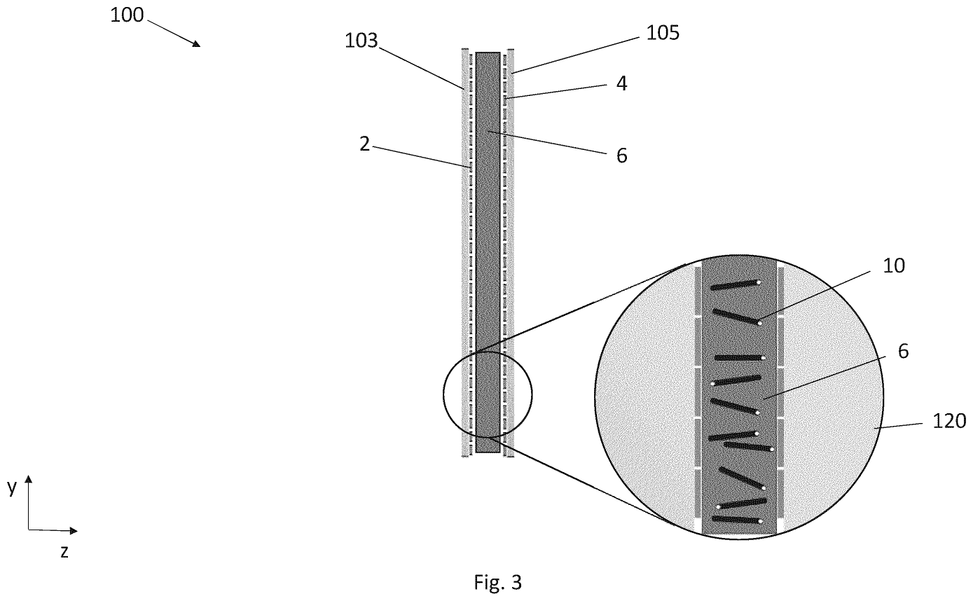

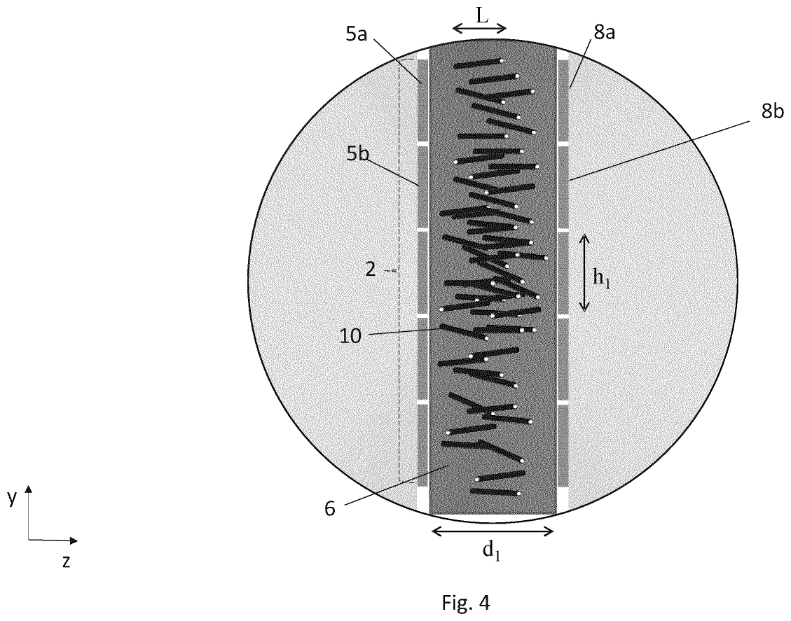

FIG. 3 is a side on cross sectional view of the window 100 of FIGS. 1 and 2 showing the layers as described above when looking along the x-axis. Inset 120 shows a zoomed in version of a region of the window's 100 cross section showing the anisotropic molecules 10 in gel layer 6. FIG. 4 shows a further detailed view of what is shown in inset 120 of FIG. 3. As can be seen the anisotropic molecules 10 are single walled carbon nanotubes have an elongate rod-like shape having a length longer than their width. A large number of anisotropic molecules 10 are shown, however in reality the concentration of active molecules 10 within the gel layer 6 will be in the μmol to mmol range. Prior to voltages being applied to the layers of electrodes the anisotropic molecules 10 may be randomly orientated as shown in FIG. 4. The gel matrix acts to support and suspend the anisotropic molecules 10 in a particular orientation so that they do not randomly move within the gel matrix. However, upon application of voltage to the electrode layers 2, 4 the orientation of the anisotropic molecules may change, as will be described in detail below.

The anisotropic molecules 10 permit transmission of radiation through the gel layer 6 dependent on their orientation. For instance, by orientating the anisotropic molecules 10 such that their longest side is parallel to the incoming radiation, the anisotropic molecules 10 may provide minimal (or no) attenuation of the radiation. Whereas orientating the anisotropic molecules 10 such that their longest side is perpendicular to the incoming radiation, the anisotropic molecules 10 may provide maximum (or full) attenuation of the radiation. Thus, by controlling the orientation of the anisotropic molecules 10, with respect to the orientation of the incoming radiation, the transfer of electromagnetic radiation (and therefore heat) through the window 100 can be controlled. The transmission of radiation through the layer is proportional to approximately sin²(Θ₁), where Θ₁ is the angle between the electric field and the molecular main axis (i.e. their longest side).

The ability to finely control the orientation of the molecules 10 requires a reasonable ratio of the width of the gel layer 6 in the z-direction (as indicated by d₁ in FIG. 4) to height of each electrode in the y-direction (as indicated by h₁ in FIG. 4). In addition, by having d₁ greater than the length of the anisotropic molecules (as indicated by L in FIG. 4) the anisotropic molecules 10 can be oriented at any angle.

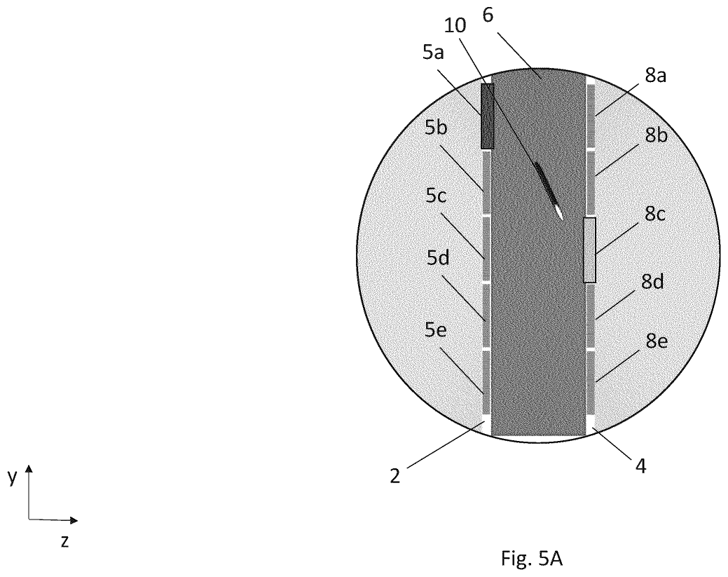

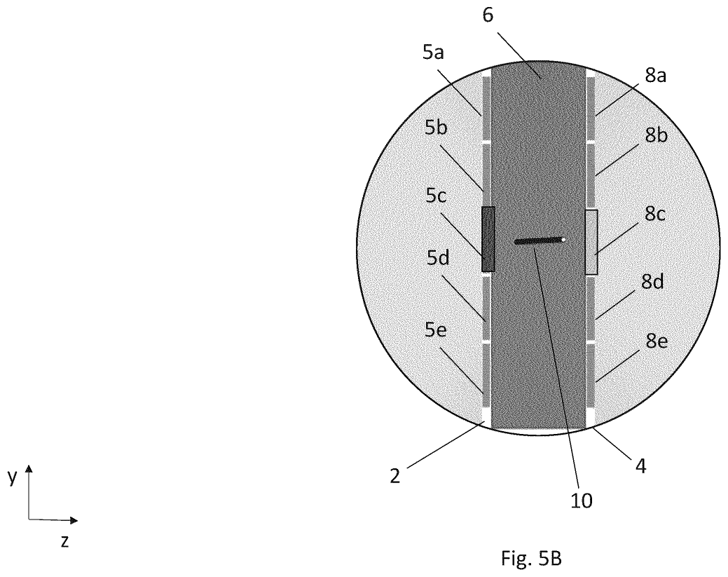

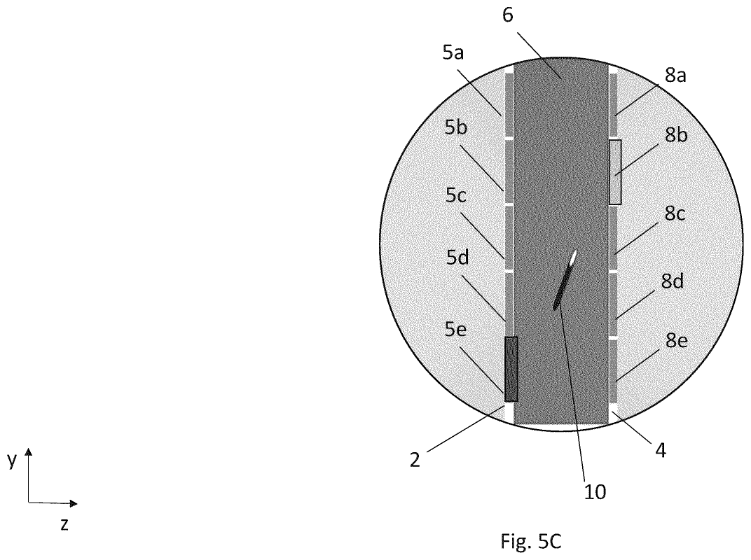

Upon application of a voltage to electrode layer 2 and electrode layer 4 a potential difference can be set up causing an electric field in the gel layer 7. If the electric field is sufficient to overcome the force provided by the gel, holding the anisotropic molecules 10 in place, this electric field can polarise the molecules 10 within the gel layer 7 such that they orientate along the electric field lines. By only applying voltage to select electrodes in each of the electrode layers 2, 4 the exact orientation of the anisotropic molecules 10 can be controlled. An example of this is shown in FIGS. 5A to 5C.

In FIG. 5A a positive voltage is applied to electrode 5a and a negative voltage to electrode 8c, thus setting up a relative potential between electrode 5a and electrode 8c. No voltage is applied to any of the other electrodes (5b, 5c, 5d, 5e, 8a, 8b, 8d, 8e). Thus, an electric field formed between electrode 5a and 8c causes the anisotropic molecules 10 between these electrodes to align along the direction of the electric field lines. As electrode 5a is at a different position to electrode 8c along the y-axis this causes the anisotropic molecules to align at an angle in the y-z plane along a line formed between electrode 5a and electrode 8c.

FIG. 5B shows a further example of how to orientate molecules 10 in a certain orientation. In FIG. 5B a voltage is applied to electrode 5c and a negative voltage to electrode 8c, thus setting up a relative potential between electrode 5c and electrode 8c. No voltage is applied to any of the other electrodes (5a, 5b, 5d, 5e, 8a, 8b, 8d, 8e). Therefore, an electric field formed between electrode 5c and 8c causes the anisotropic molecules 10 between these electrodes to align along the direction of the electric field lines. In this example the electrode 5c is at the same position to electrode 8c along the y-axis, which causes the anisotropic molecules to align along the z-axis, i.e., along a line formed between electrode 5c and electrode 8c.

FIG. 5C shows a further example of how to orientate molecules 10 in a certain orientation. In FIG. 5C a positive voltage is applied to electrode 5e and a negative voltage to electrode 8b, thus setting up a relative potential between electrode 5e and electrode 8b. No voltage is applied to any of the other electrodes (5a, 5b, 5c, 5d, 8a, 8c, 8d, 8e). Thus, an electric field formed between electrode 5e and 8b causes the anisotropic molecules 10 between these electrodes to align along the direction of the electric field. In this example the electrode 5e is at a different position to electrode 8b along the y-axis which causes the anisotropic molecules to align at an angle in the y-z plane along a line formed between electrode 5e and electrode 8b.

FIGS. 5A to 5C demonstrate how the electrodes can be independently controlled. In the arrangements shown in FIG. 5B radiation incident along the window along the z-direction would pass through the window unimpeded due to the molecules 10 being aligned along the z-axis. In comparison, the arrangements shown in FIGS. 5A and 5C would provide some attenuation to the radiation passing along the z-direction as molecules 10 have an orientation with some y-component.

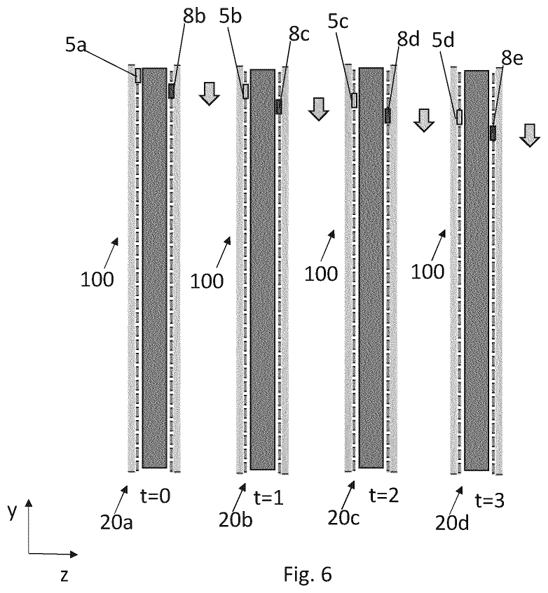

In certain instances, it may be desired that all the anisotropic molecules 10 within the gel layer 6 are orientated in the same direction. One way in which this may be achieved is shown in FIG. 6 which shows a series of side on cross sectional views of window 100 at a series of points in time. At t=0, as shown in 20a, a voltage is applied to only electrodes 5a and 8b setting up a potential difference between these two electrodes. This causes the anisotropic molecules in the region between these two electrodes to orientate in a direction between the electrodes 5a and 8b. At t=1, as shown in 20b, a voltage is applied to only electrodes 5b and 8c setting up a potential difference between these two electrodes. This causes the anisotropic molecules in the region between these two electrodes to orientate in a direction between the electrodes 5b and 8c. At t=2, as shown in 20c, a voltage is applied to only electrodes 5c and 8d setting up a potential difference between these two electrodes. This causes the anisotropic molecules in the region between these two electrodes to orientate in a direction between the electrodes 5c and 8d. At t=3, as shown in 20d, a voltage is applied to only electrodes 5d and 8e setting up a potential difference between these two electrodes. This causes the anisotropic molecules in the region between these two electrodes to orientate in a direction between the electrodes 5d and 8e. By continuing this pattern along the whole length of the electrode layers, i.e., applying a potential difference in the way shown in 20a-20d along the whole length of the electrode layers, the anisotropic molecules along the entire length of the gel layer 6 can be orientated in the same direction. As the difference in position (along the y-axis) of the electrodes to which a voltage is applied is the same at each moment in time (i.e., between 20a, 20b, 20c and 20d) the molecules along the length of the gel layer 7 are caused to orientate in the same direction to each other.

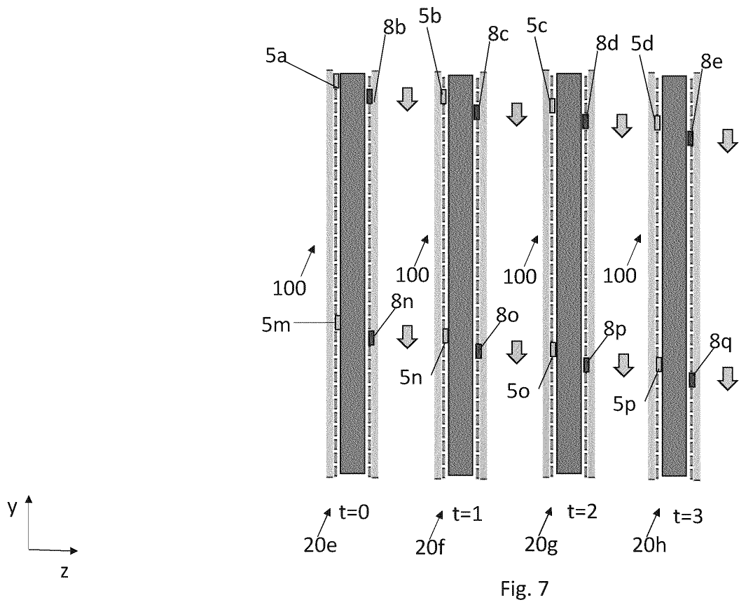

FIG. 7, which shows a series of side on cross sectional views of window 100 at a series of points in time, demonstrates a further way in which all the anisotropic molecules 10 within the gel layer 6 can be orientated in the same direction. Between time t=0 and t=3 a voltage is applied to the electrodes 5a-5d, and 8b-8e as described above in relation to FIG. 6 between time t=0 and t=3. However, in addition at t=0, as shown in 20e, a voltage is applied to electrodes 5m and 8n, in addition to electrodes 5a and 8b, setting up a potential difference between electrodes 5m and 8n. This causes the anisotropic molecules in the region between these two electrodes to orientate in a direction between the electrodes 5m and 8n. Likewise, at t=1, as shown in 20f, a voltage is applied to electrodes 5n and 8o, in addition to electrodes 5b and 8c, setting up a potential difference between electrodes 5n and 8o. This causes the anisotropic molecules in the region between these two electrodes to orientate in a direction between the electrodes 5n and 8o. At t=2, as shown in 20g, a voltage is applied to electrodes 5o and 8p, in addition to electrodes 5c and 8d, setting up a potential difference between electrodes 5o and 8p. This causes the anisotropic molecules in the region between these two electrodes to orientate in a direction between the electrodes 5o and 8p. At t=3, as shown in 20h, a voltage is applied to electrodes 5p and 8q, in addition to electrodes 5d and 8e, setting up a potential difference between electrodes 5p and 8q. This causes the anisotropic molecules in the region between these two electrodes to orientate in a direction between the electrodes 5p and 8q.

Although molecules that are neighbouring the region between the two electrodes to which a potential difference has been applied may experience a residual electric field this will drop off with distance and will provide a negligible effect on the overall ordering of the molecules achieved using the methods shown above. In any case, as electrodes 5m-5p and 8n-8q are sufficiently far from electrodes 5a-5d, and 8b-8e then the electric field from electrodes 5m-5p and 8n-8q does not have an impact on the molecules in the region between electrodes 5a-5d, and 8b-8e, and vice versa. Therefore, the speed of switching molecule orientation throughout the device can by increased by applying the voltage to electrodes in different regions that are sufficiently far apart. The difference in position (along the y-axis) of the electrodes 5m-5p and 8n-8q is the same as between electrodes 5a-5d, and 8b-8e to ensure the same orientation of the molecules.

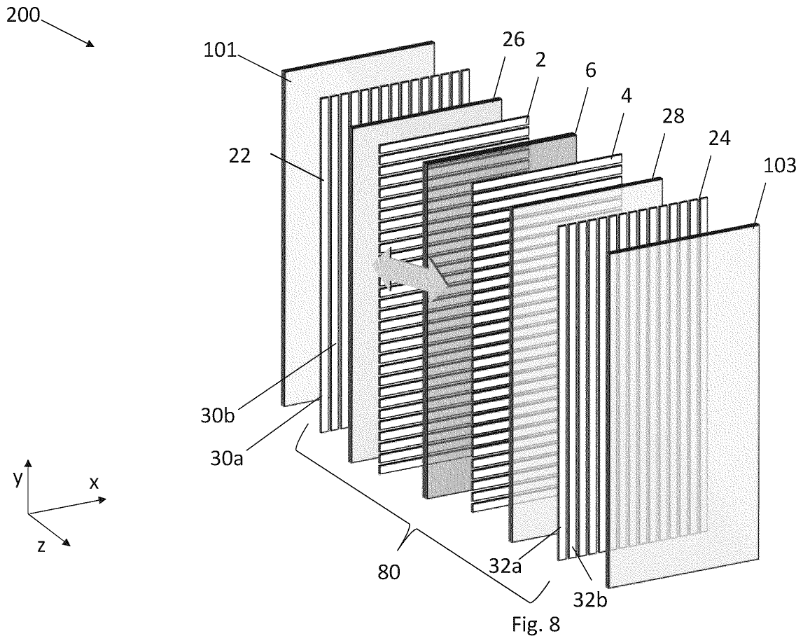

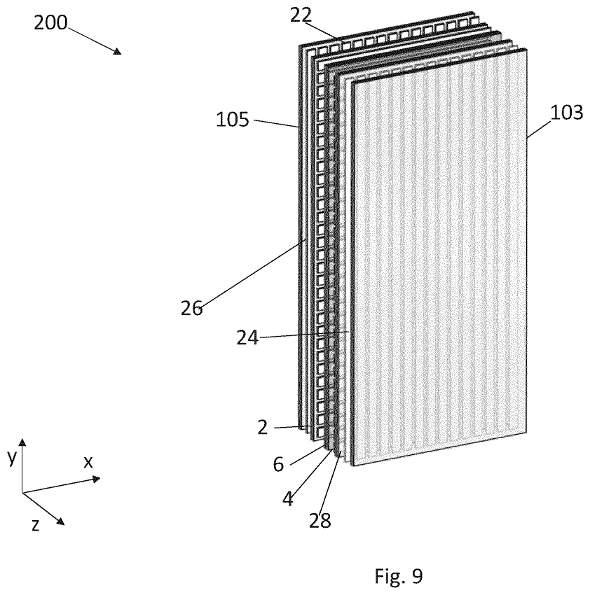

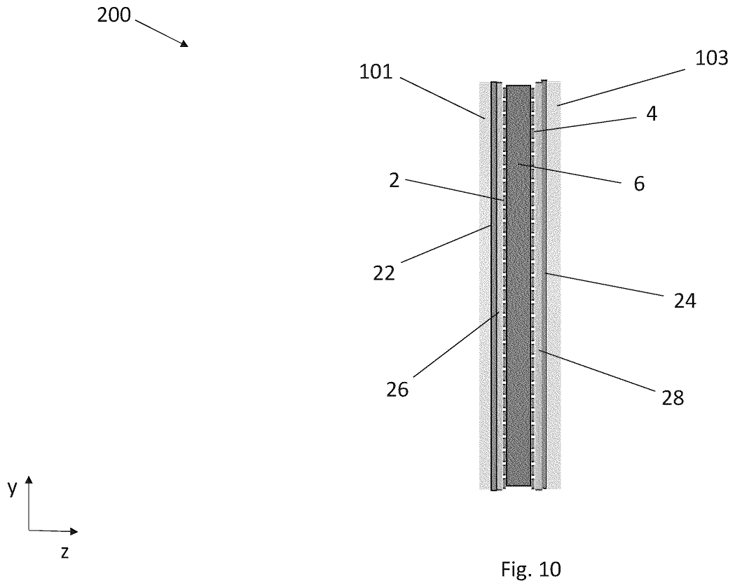

FIG. 8 is a perspective exploded view of a window 200 comprising a mechanism 80 for controlling the transmission of electromagnetic radiation through the window according to a further aspect of the invention. FIG. 9 is a perspective view of the window 200, comprising mechanism 80 for controlling the transmission of electromagnetic radiation through the window, of FIG. 8. FIG. 10 is a side on cross sectional view of the window 200 of FIGS. 8 and 9 showing the layers when looking along the x-axis.

As can be seen from FIGS. 8 and 9 window 200 is formed of glass panes 101 103, and has electrode layer 2 and electrode layer 4, and gel layer 6 as consistent with window 100 in FIGS. 1 and 2. However, further layers are present in the window 200 of FIG. 8 compared to window 100.

Specifically, a further electrode layer 22 is located between electrode layer 2 and windowpane 101. Insulating layer 26 is located between electrode layer 2 and further electrode layer 22. Insulating layer 26 is formed of insulating material that ensures that short circuits do not occur between the electrode layer 2 and electrode layer 22. In addition, a further electrode layer 24 is located between electrode layer 4 and windowpane 103. Insulating layer 28 is located between electrode layer 4 and further electrode layer 24. Insulating layer 28 is formed of insulating material that ensures that short circuits do not occur between the electrode layer 4 and electrode layer 24. The insulating material of the insulating layers 26 28 may be any type of insulating transparent polymers, (including polycarbonate, polyethylene, PVC, polyester, polystirole), or glass, or thin oxides, or any other known insulating material.

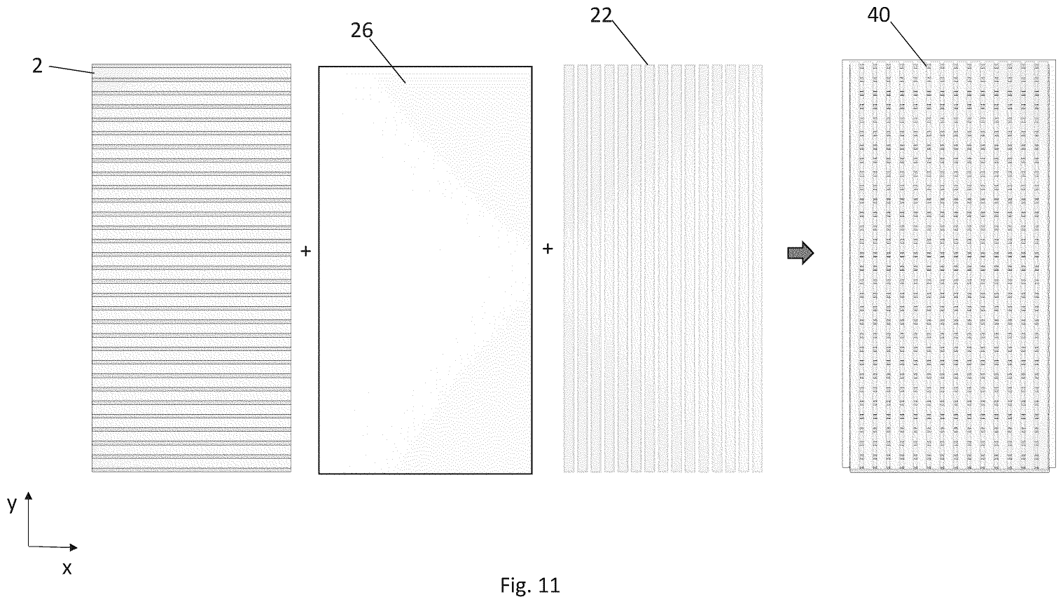

The layer of electrodes 22 contains a plurality of electrodes (such as 30a 30b) arranged within the layer. Likewise, the layer of electrodes 24 contains a plurality of electrodes (such as 32a 32b) arranged within the layer. The electrodes of both layer 22 and layer 24 each have an elongate shape that extends along an axis which is orthogonal to the direction in which the elongate electrodes in layer 2 and layer 4 extend. i.e., the y-axis as shown in FIGS. 8 and 9. Each of the plurality of electrodes of the layer 22 are spaced apart from each other along the x-axis by an insulating gap, and each of the plurality of electrodes of the layer 24 are spaced apart from each other along the x-axis by an insulating gap. Each layer of electrodes (i.e., layer 22, layer 2, layer 4 and layer 24) are separated from each other along the z-axis (as shown in FIGS. 8 and 9). FIG. 11 shows front on views of electrode layer 2, insulation layer 26 and electrode layer 22. The combination of each of these layers is shown as layer 40.

The purpose of the additional electrode layers 24 22 in the arrangement shown in FIGS. 8 to 10 can enable control of orientation of the anisotropic molecules 10 over a further range of angles. As electrode layers 24 and 22 are arranged orthogonal to those in layer 2 and 4 by controlling the voltage applied to each of the electrodes of layer 24 and 22 in a similar manner as described in relation to FIGS. 6 and 7, but along the x-axis rather than the y-axis (owing to the different arrangement of the electrodes in these layers).

A non-zero voltage may be applied to electrode layers 24 22 at a different point in time to electrode layers 2 4 so that the electric fields generated by layer 24 22 are not affected by layers 2 4. However, in other arrangements, a non-zero voltage may be applied to electrode layers 24 22 and electrode layers 2 4 at the same time so that the electric fields generated will be a complex combination from each of the electrode layers.

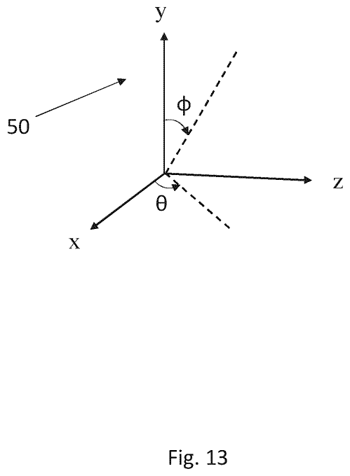

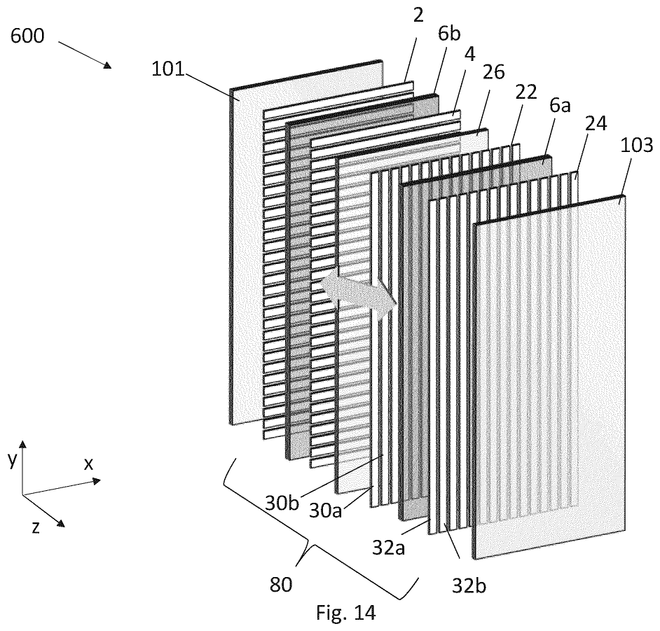

FIG. 13 shows the axis system 50, as shown in the FIGS. 1 to 12 (and FIG. 14), showing the angles over which the anisotropic molecules 10 can be orientated. Electrode layers 2 and electrode layer 4 control the orientation of anisotropic molecules 10 over the (elevation) angle φ (as shown in FIGS. 5A to 5C above). Electrode layers 22 and electrode layer 24 control the orientation of anisotropic molecules 10 over the (azimuth) angle θ. Thus window 100 shown in FIGS. 1 to 3 can be used to orientate molecules over (elevation) angle φ only. Whereas window 200 in FIGS. 8 to 10 (and window 600 in FIG. 14) can be used to orientate molecules over both (elevation) angle φ and (azimuth) angle θ. In some uses orientation over only either elevation angle φ or azimuth angle θ may be sufficient. However, by having a greater control of orientation of molecules over both elevation and azimuth angles molecule orientation can be tailored to control radiation incident on the window from a wider variety of directions (e.g. both perpendicular polarisation directions).

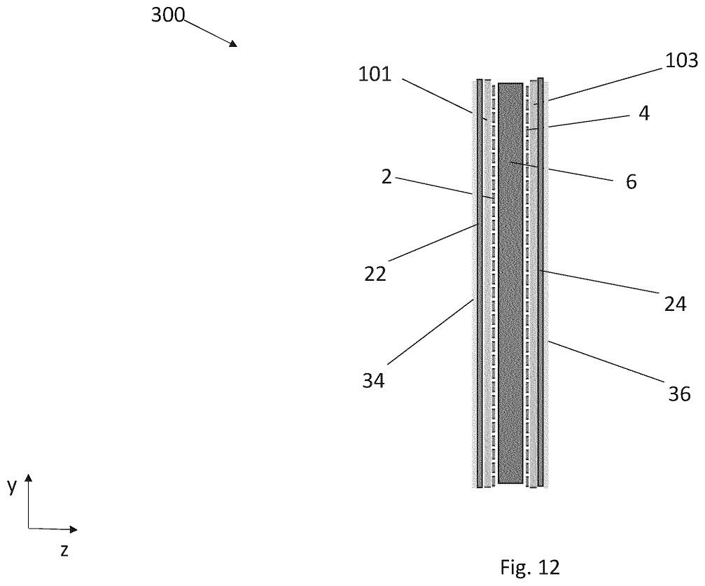

FIG. 12 shows a side on cross sectional view of a window 300 according to a further arrangement, showing the layers when looking along the x-axis. The window 300 of FIG. 12 has the same number and arrangement of electrodes layers as in window 200 of FIG. 8 but having the layers differently arranged along the z-axis. Specifically, window 300 is identical to the arrangement of layers in window 100, as described in relation to FIGS. 1 to 3, but with additional layers arranged on the outer major surfaces of windowpanes 101 and 103. Specifically, electrode layer 22 is arranged on outer major surface of pane 101 (such that pane 101 is sandwiched between electrode layers 22 and 2). Electrode layer 24 is arranged on outer major surface of pane 103 (such that pane 103 is sandwiched between electrode layers 24 and 4). Outer coatings 36 and 34 are located on the side of the electrode layers 22 24 opposite to the windowpanes 101 103. The outer coatings 36 34 aid to protect the electrode layers 22 24. Control of radiation through the window 300 of FIG. 12 is carried out by applying voltage to the layers of electrodes in the same way as described in relation to FIGS. 8 and 9 above.

FIG. 14 is a perspective exploded view of a window 600 comprising a mechanism 80 for controlling the transmission of electromagnetic radiation through the window 600 according to a further aspect of the invention.

As can be seen from FIG. 14 window 600 is formed of glass panes 101 103, and has electrode layers 2, 4, 22 and 24 as consistent with window 200 in FIG. 8. However, the arrangement of the electrode layers is different when compared to the electrode layers in window 200 of FIG. 8. There is also two gel layers 6a and 6b in the arrangement in FIG. 14, rather than a single gel layer. Specifically, electrode layers 2 and 4 are on either side (i.e. sandwich) gel layer 6b, and electrode layers 22 and 24 are on either side (i.e. sandwich) gel layer 6a. In this arrangement, only a single insulating layer 26 is required separating the electrode layers 4 and 22.

The arrangement of electrode layers in window 600 is such that potential difference applied to electrode layers 2 and 4 (in the manner as described above in relation to FIGS. 5A to 7) results in an electric field being generated in gel layer 6b causing the molecules 10 in gel layer 6b to be orientated as described above. Whereas potential difference applied to electrode layers 22 and 24 results in an electric filed being generated in gel layer 6a causing the molecules 10 in gel layer 6a to be orientated as described above. Thus, the orientation of molecules 10 in gel layer 6b are controlled by the electrodes in layer 2 and 4, i.e., over the (elevation) angle φ. Whereas the orientation of molecules 10 in gel layer 6a are controlled by the electrodes in layer 22 and 24, i.e., over the (azimuth) angle θ. In this way, each layer 6a 6b may be configured to attenuate a different polarisation direction of the incoming radiation to each other through the controlling of the molecule orientation.

For each of the above examples, the windows 100 200 300 600 may be installed in a building such that the windowpane 103 is the external windowpane on the outside of the building and windowpane 101 is the internal windowpane on the inside of the building. Radiation, such as from the sun, is first incident on pane 103 on major surface 105. The radiation passes through the pane 103 and through the transparent electrode layer 4 (and 24 in FIGS. 12 and 10) before subsequently incident on gel layer 6. Depending on the orientation of the molecules in the gel layer 6 the radiation will either pass through (or a portion thereof will) or be attenuated (via absorption and reflection) by the gel layer. The radiation (if not attenuated) will then pass through the transparent electrode layer 2 (and 22 in FIGS. 12 and 10) and through the pane 101. Radiation may also travel through the opposite direction (i.e., from pane 101 to pane 103) from inside the building to outside.

The windows 100 200 300 600 each will further comprise a voltage source (not shown) which is capable of supplying the voltage to electrode layers 2, 4, 22, 24. The voltage source may be a power supply such as mains powered, or battery powered. The voltage may be a DC voltage or AC voltage. As the gel layer 7 has a density such that the anisotropic molecules 10 can change orientation only under the influence of the electric field the voltage needs only be applied to the electrodes when their orientation needs to be changed, i.e., when the thermal properties of the window is to be altered. Advantageously, this means that the amount of power consumed by the device can be kept low as power is only required when a change is required, rather than continuously.

The device may also include a management device that is capable of controlling the voltage applied to the electrodes to tailor the radiation transmission of the windows. This management device may comprise a microprocessor and be programmable by a human operator such that the performance of the window can be altered by the user. Alternatively, the management device may have in-built algorithms such that it is capable of detecting parameters (such as inside, and outside temperatures, or the direction of incident light) so as to automatically adjust the transmission through the window by the means described above.

The windows 100 200 300 600 shown here may be any type of window containing more than one pane of glass. For instance, they may be double glazed windows with panes 101 and 103 forming the two panes of the double-glazing unit. Alternatively, they may be triple glazed windows with further panes of glass to those shown. The panes 101 103 have a rectangular shape but it would be understood that they may be any shape to fit the window recess. The panes 101 and 103 are transparent glass substrates. However, the present invention may equally be used in other types of substrates for instance plastic, such as Perspex™.

The above description is presented to enable any person skilled in the art to make and use the system and is provided in the context of a particular application. Various modifications to the disclosed embodiments will be readily apparent to those skilled in the art.

The electrode layers 2, 4, 22, 24 are made from Indium Tin Oxide (ITO). However, could be made from any type of electrically conductive material such as aluminium, silver, gold, or any thin metal, or transparent conductive oxides including (ITO, TCO), or conductive organic molecules.

In the arrangement shown in FIG. 1 the electrodes are arranged such that they are elongate along the x-axis only and thus control orientation of molecules over (elevation) angle φ only. However, in other arrangements the window may have electrodes that are arranged such that they are elongate along the y-axis only and thus control orientation of molecules over (azimuth) angle θ only.

Although the electrodes in the layers of the windows described above are elongate, in other arrangements they need not necessarily be so. In other arrangements they may have a square shape, such that each elongate electrode shown in FIG. 1, for example, are split into a series of square electrodes. Each of the square electrodes are independently controllable. Applying a voltage to a row or column of electrodes in this manner may enable the same effects as described above in relation to the arrangements having elongate arrangements of electrodes. However, having square electrodes may enable a greater control of orientations achievable. Although the electrodes are shown as being straight in other arrangements the electrodes may be curved. In other arrangements, the electrodes may be arranged diagonally with respect to panes 103 and 101 rather than parallel to either the x or y axis. For instance, the electrodes 2, 4 may be arranged diagonally in an opposite direction to electrodes 22 24 to achieve the same effect as described in the above arrangements.

The examples shown in the figures are only a select number of examples of the arrangements of the layers. In other arrangements the layers may be arranged differently with respect to the panes of glass 101 103. For instance, electrode layers 2 and 4 may be arranged on the other side of panes 101 103.

The anisotropic molecules in the described examples are single walled carbon nanotubes. However, any type of anisotropic particle may be used so long as its orientation can affect the passage of radiation through the device. The term anisotropic is used to denote a molecule exhibiting properties with different values when measured in different directions. Anisotropic shaped molecules are non-spherical molecules whose shape can typically be approximated by a simplified shape having a long axis and a much shorter axis, e.g. in rod-shaped.

Although the devices are described in relation to windows for buildings the above arrangements may be used in any type of window. For instance, windows for a vehicle, or machinery may employ these above-described arrangements. In addition, the invention may not necessary be limited to windows and may be applicable for use on any type of glass product.

In addition, the mode of operation described above in relation to FIGS. 6 and 7 are just a few examples of how the device may be used. The choice of which electrodes to apply voltage to at each point in time may be varied dependent on device use. For instance, it may be desired that only a portion of the window is controlled to prevent radiation through that region of the window—so voltage is applied to electrodes only at that point. Whereas no voltage may be applied to electrodes in other regions of the window where it is not required to reduce the passage of radiation through the window.

In the above-described examples the molecules are configured to aid in the modulation of electromagnetic radiation of a variety of wavelengths through the window. For instance, both UV, visible and IR radiation are modulated by the anisotropic molecules. However, in other arrangements the molecules may be configured to modulate only one specific wavelength band. For instance, blocking IR but allowing passage of IR radiation.

Altering the transmission of electromagnetic radiation in the above described examples is caused by the anisotropic molecules which, depending on their orientation, absorb and/or reflect light therefore altering the thermal radiation properties of the window. However, thermal conductivity along the long axis of the molecules is typically much higher (for carbon nanotubes by as much as orders of magnitude) than in a perpendicular direction. This can provide a further means of improvements of energy efficiency. However, as the molecules are embedded into a window (such as a double or triple pane window) this thermal conductivity does not play a significant role in practice, and the predominate effects are based on the transmission attenuation of the thermal radiation.

It is noted that polarisation of TEM waves is always perpendicular to their propagation direction i.e. the plane of polarisation of the incoming light will be perpendicular to the direction of the light. Minimum transmission can be reached when all polarisations within that plane can be rejected (through absorption and/or reflection). It is sufficient to arbitrarily choose two perpendicular (to each other) polarisations within that plane to reach minimum transmission, i.e. by arranging the electrodes in the different layers (layers 2 and 4 compared to layers 24 and 22) substantially perpendicular to each other—but the arrangement need not necessarily be the horizontal and vertical orientation of the electrodes as shown in the above figures but may be arranged at any angle so long as the sets of layers are perpendicular to each other in the x-y plane which is perpendicular to the incoming direction of the radiation.

The arrangement in FIGS. 8 and 14 allows light having the polarisation in orthogonal axes to be blocked by having four electrode layers. However, a similar effect could be achieved with FIG. 1 by having a layer of polarising filter to block the light in the axes that is not blocked by layers 2 and 4. In other arrangements, more than four electrode layers may be present, or more than 2 layers of carrier material (i.e. gel layer) if desired.

Although not shown in any of the arrangements above, in some arrangements there may be an additional insulative layer between the electrodes and the gel layers. For instance, between electrode layer 2 and gel layer 6b in FIG. 14, or for instance between electrode layer 2 and gel layer 6 in FIG. 1. The purpose of the insulative layer between the electrodes and gel layers may be to serve as a thin protective layer to enable higher voltages (if so desired) to be used in conjunction with a hydro-gel within the gel layer without getting unwanted electrolysis.

1. A device for controlling transmission of electromagnetic radiation through a transparent substrate the device comprising:
a first plurality of electrodes arranged as a first layer, the first layer defined by a first axis and a second axis, where the second axis is orthogonal to the first axis, the first plurality of electrodes spaced apart from each other along the first axis, at least some of the first plurality of electrodes configured to be independently controllable to each other;
a second plurality of electrodes arranged as a second layer, the second layer defined by the first axis and the second axis, the second plurality of electrodes spaced apart from each other along the first axis, and the second layer spaced apart from the first layer along an axis perpendicular to the first and second axis, at least some of the second plurality of electrodes configured to be independently controllable to each other;
a carrier material located between the first plurality of electrodes and the second plurality of electrodes, the carrier material comprising:
a plurality of molecules configured to change their orientation in the presence of an electric field thereby to alter the transmission of electromagnetic radiation through the device;
wherein the first plurality of electrodes and the second plurality of electrodes are configured to generate an electric field in the carrier material upon application of a potential difference between the first and second plurality of electrodes, such that the plurality of molecules orientate along a direction in the presence of the electric field between the first axis and the axis perpendicular to the first and second axis, thereby to alter the transmission of electromagnetic radiation through the device.

2. The device of claim 1, wherein the first plurality of electrodes and the second plurality of electrodes are configured such that when a potential difference is applied between a first electrode of the first plurality of electrodes, positioned at a first position along the first axis, and a first electrode of the second plurality of electrodes, positioned at a second position along the first axis, the molecules are configured to orientate along a direction defined between the first position and the second position.

3. The device of claim 2, wherein the first position is at a different position along the first axis to the second position.

4. The device of claim 1, further comprising a third plurality of electrodes spaced apart from each other substantially along the second axis, the third plurality of electrodes configured to be independently controllable to each other; and
a fourth plurality of electrodes spaced apart from each other substantially along the second axis, the fourth plurality of electrodes configured to be independently controllable to each other;

5. The device of claim 4, wherein the third plurality of electrodes and the fourth plurality of electrodes are configured to generate an electric field in the carrier material upon application of a potential difference between the third and fourth plurality of electrodes, such that the plurality of molecules orientate along a direction in the presence of the electric field between the second axis and the axis perpendicular to the first and second axis thereby to alter the transmission of electromagnetic radiation through the device.

6. The device of claim 4, wherein the carrier material is a first layer of carrier material, and the device further comprises:
a second layer of carrier material comprising a plurality of molecules, the second layer of carrier material arranged between the third plurality of electrodes and the fourth plurality of electrodes, wherein the third plurality of electrodes and the fourth plurality of electrodes are configured to generate an electric field in the second layer of carrier material upon application of a potential difference between the third and fourth plurality of electrodes, such that the plurality of molecules in the second layer of carrier material orientate along a direction in the presence of the electric field between the second axis and the axis perpendicular to the first and second axis thereby to alter the transmission of electromagnetic radiation through the device.

7. The device of claim 1, wherein each of the first plurality of electrodes, and/or second plurality of electrodes are elongate such that they extend substantially along the second axis.

8. The device of claim 1, wherein the molecules are carbon nanotubes.

9. The device of claim 1, wherein the transparent substrate is for use in a window.

10. A window comprising:
the device of claim 1; and
a windowpane comprised of transparent substrate.

11. The window of claim 10, comprising a first windowpane and a second windowpane positioned apart from each other along the axis perpendicular to the first and second axis, wherein the device is located in a region defined between the first and second windowpanes, such that the first plurality of electrodes are adjacent to the first windowpane and the second plurality of electrodes are adjacent to the second windowpane.

12. The window of claim 11, wherein the device further comprises a third plurality of electrodes spaced apart from each other substantially along the second axis, the third plurality of electrodes configured to be independently controllable to each other; and a fourth plurality of electrodes spaced apart from each other substantially along the second axis, the fourth plurality of electrodes configured to be independently controllable to each other; and
wherein the window comprise a first windowpane and a second windowpane positioned apart from each other along the direction perpendicular to the first and second axis, wherein the first windowpane is located between the first plurality of electrodes and the third plurality of electrodes, and the second windowpane is located between the second plurality of electrodes and the fourth plurality of electrodes.

13. The window of claim 10, wherein the windowpane has a first major surface and a second major surface, the first and second major surfaces defined by the first and second axes.

14. The window according to claim 10, wherein the transparent substrate is glass.

15. A method of controlling transmission of electromagnetic radiation through a transparent substrate the method comprising:
arranging a first plurality of electrodes as a first layer, the first layer defined by a first axis and a second axis, where the second axis is orthogonal to the first axis, the first plurality of electrodes spaced apart from each other along the first axis, at least some of the first plurality of electrodes configured to be independently controllable to each other;
arranging a second plurality of electrodes as a second layer, the second layer defined by the first axis and the second axis, the second plurality of electrodes spaced apart from each other along the first axis, and the second layer spaced apart from the first layer along an axis perpendicular to the first and second axis, at least some of the second plurality of electrodes configured to be independently controllable to each other;
arranging a carrier material located between the first plurality of electrodes and the second plurality of electrodes, the carrier material comprising: a plurality of molecules configured to change their orientation in the presence of an electric field thereby to alter the transmission of electromagnetic radiation through the device;
wherein the first plurality of electrodes and the second plurality of electrodes are configured to generate an electric field in the carrier material upon application of a potential difference between the first and second plurality of electrodes, such that the plurality of molecules orientate along a direction in the presence of the electric field between the first axis and the axis perpendicular to the first and second axis thereby to alter the transmission of electromagnetic radiation through the device.

16. The method of claim 15, further comprising:
applying a potential difference between a first electrode of the first plurality of electrodes, positioned at a first position along the first axis, and a first electrode of the second plurality of electrodes, positioned at a second position along the first axis, such that the molecules located in a region defined between the first electrode of the first plurality of electrodes and the first electrode of the second plurality of electrodes orientate along a direction defined between the first position and the second position.

17. The method of claim 16, further comprising:
switching off the potential difference between the first electrode of the first plurality of electrodes, positioned at the first position along the first axis, and the first electrode of the second plurality of electrodes, positioned at the second position along the first axis; and
subsequently to the step of switching off:
applying a potential difference between a second electrode of the first plurality of electrodes, positioned at a third position along the first axis, and a second electrode of the second plurality of electrodes, positioned at a fourth position along the first axis, such that the molecules, located in a region defined between the second electrode of the first plurality of electrodes and the second electrode of the second plurality of electrodes, orientate along a direction defined between the third position and the fourth position;
wherein the first position is different to the third position, and the second position is different to the fourth position.

18. The method of claim 15, wherein altering the transmission of electromagnetic radiation may include reducing the transmission.

19. The device of claim 1, wherein altering the transmission of electromagnetic radiation may include reducing the transmission.
